(19) United States
(12) Patent Application Publication
(10) Pub. No.: US 2014/0009465 A1
(43) Pub. Date: Jan. 9, 2014

(54) METHOD AND APPARATUS FOR MODELING THREE-DIMENSIONAL (3D) FACE, AND METHOD AND APPARATUS FOR TRACKING FACE

(71) Applicant: SAMSUNG ELECTRONICS CO., LTD., Suwon (KR)

(72) Inventors: Xiaolu Shen, Beijing (CN); Xuetao Feng, Beijing (CN); Hui Zhang, Beijing (CN); Ji Yeun Kim, Seoul (KR); Jung Bae Kim, Hwaseong (KR)

(73) Assignee: SAMSUNG ELECTRONICS CO., LTD., Suwon (KR)

(21) Appl. No.: 13/936,001

(22) Filed: Jul. 5, 2013

(30) Foreign Application Priority Data
Jul. 5, 2012 (CN) 201210231897.X
Apr. 19, 2013 (KR) 10-2013-0043463

(51) Int. Cl. G06T 13/40

(52) U.S. Cl. CPC G06T 13/40
USPC 345/420

(57) ABSTRACT

A method and apparatus for modeling a three-dimensional (3D) face, and a method and apparatus for tracking a face. The method for modeling the 3D face may set a predetermined reference 3D face to be a working model, and generate a result of tracking including at least one of a face characteristic point, an expression parameter, and a head pose parameter from a video frame, based on the working model, to output the result of the tracking.

### CROSS-REFERENCE TO RELATED APPLICATIONS

This application claims the priority benefit of Korean Patent Application No. 10-2013-0043463, filed on Apr. 19, 2013, in the Korean Intellectual Property Office, and Chinese Patent Application No. 201210231897.X, filed on Jul. 5, 2012, in the Chinese Patent Office, the disclosures of each of which are incorporated herein by reference.

### BACKGROUND

1. Field

Example embodiments of the following disclosure relate to a method and apparatus for modeling a three-dimensional (3D) face, and a method and apparatus for tracking a face, and more particularly, to a method for modeling a 3D face that provides a 3D face most similar to a face of a user, and outputs high accuracy facial expression information by performing tracking of a face and modeling of a 3D face in a video frame including a face inputted continuously.

2. Description of the Related Art

Related technology for tracking/modeling a face may involve outputting a result with various levels of complexity, through a continuous input of video. For example, the related technology for tracking/modeling the face may output a variety of results based on various factors, including but not limited to a type of an expression parameter, an intensity of an expression, a two-dimensional (2D) shape of a face, a low resolution three-dimensional (3D) shape of a face, and a high resolution 3D shape of a face.

In general, the technology for tracking/modeling the face may be classified into technology for identifying a face of a user, fitting technology, and regeneration technology for modeling. Some of the technology for tracking/modeling the face may use a binocular camera or a depth camera. For example, a user may perform 3D modeling of a face using a process of setting a marked key point, registering a user, maintaining a fixed expression when modeling, and the like.

### SUMMARY

The foregoing and/or other aspects are achieved by providing a method for modeling a three-dimensional (3D) face, the method including setting a predetermined reference 3D face to be a working model, and tracking a face in a unit of video frame, based on the working model, generating a result of the tracking including at least one of a face characteristic point, an expression parameter, and a head pose parameter from the video frame, updating the working model, based on the result of the tracking.

The method for modeling the 3D face may further include training a reference 3D face, in advance, through off-line 3D face data, and setting the trained reference 3D face to be a working model.

The foregoing and/or other aspects are achieved by providing an apparatus for modeling a 3D face, the apparatus including a tracking unit to track a face based on a working model with respect to a video frame inputted, and generate a result of tracking including at least one of a face characteristic point, an expression parameter, and a head pose parameter, and a modeling unit to update the working model, based on the result of the tracking.

The apparatus for modeling the 3D face may further include training a 3D reference face, in advance, through off-line 3D face data, and setting the trained reference to be a working model.

The modeling unit may include a plurality of modeling units to repeatedly perform updating of the working model through alternative use of the plurality of modeling units.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1A illustrates a method for modeling a three-dimensional (3D) face, according to example embodiments;

FIG. 1B illustrates a process of updating a working model in conducting a method for modeling a 3D face, according to example embodiments;

FIG. 1C illustrates a method for tracking a face, according to example embodiments;

FIG. 2 illustrates an example of generating a 3D face, based on a general face, according to example embodiments;

FIG. 3 illustrates an example of extracting a face sketch from a video frame, according to example embodiments;

FIG. 4 illustrates an example of performing characteristic point matching and sketch matching, according to example embodiments; and

FIGS. 5A and 5B illustrate an apparatus for tracking/modeling a face, according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

A method for modeling a three-dimensional (3D) face and a method for tracking a face may be conducted in a general computer or a dedicated processor. The general computer or the dedicated processor may be configured to implement the method for modeling and the method for tracking. The method for modeling the 3D face may include setting a predetermined high accuracy reference 3D face to be used as a working model for a video frame, inputted continuously, or to be a working model within a predetermined period of time, e.g., a few minutes. Further, the reference 3D face may include a face shape, and tracking of a face of a user may be based on the set working model.

In a following step, the method for modeling the 3D face may perform updating/correcting of the working model with respect to a predetermined number of faces, based on a result of the tracking. Subsequent to the updating/correcting of the working model, the method for modeling the 3D face may continuously track the face with respect to the video frame until a 3D face reaching a predetermined threshold value is obtained, or until the tracking of the face and the updating/correcting of the working model is completed for all video frames. A result of the tracking including accurate expression information and head pose information may be outputted in the updating/correcting, or subsequent to the updating/correcting being completed, the 3D face generated may be outputted, as necessary.

The video frames continuously outputted may refer to a plurality of images or video frames captured by a general digital camera, and extracted or processed through streaming of a digital video. Further, the video frames may also refer to a plurality of images or video frames continuously captured by a digital camera. The video frames being continuously inputted may be inputted to a general computer or a dedicated processor for the method for modeling the 3D face and the method for tracking the face, via an input/output interface.

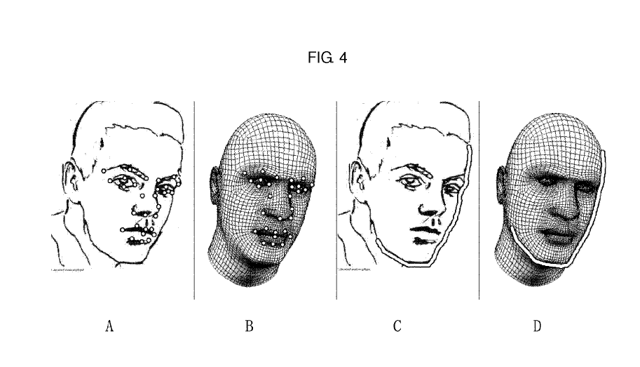

FIG. 4 illustrates an example of a 3D face generated based on a predetermined face set as a working model. The generated 3D face may include a 3D shape of a face, appearance parameters, expression parameters, and head pose parameters, however, the present disclosure is not limited thereto. A working model of the 3D face may be represented by Equation 1, shown below.

S(a, e, q)=T(ΣaᵢSᵢ^{a}+ΣeⱼSⱼ^{e}; q) [Equation 1]

Here, “S” denotes a 3D shape, “a” denotes an appearance component, “e” denotes an expression component, “q” denotes a head pose, “T(S, q)” denotes a function performing an operation of rotating or an operation of moving a 3D shape “S” based on the head pose “q”.

According to the example embodiments, a reference 3D face may be trained off-line, in advance, through high accuracy face data of differing expressions and poses. According to other example embodiments, a reference 3D face may be obtained by a general process. Alternatively, a 3D face including characteristics of a reference face may be determined to be the reference 3D face, as necessary.

Referring to Equation 1, the reference 3D face may include an average shape “s^{o}”, an appearance component “Sᵢ^{a}”, an expression component “Sⱼ^{e}”, and a head pose “q^{o}”. The average shape “s^{o}” denotes an average value of a total of training samples, and respective components of the appearance component “Sᵢ^{a}(i=1:N)” denotes a change in a face appearance. The expression component “Sⱼ^{e}(j=1:M)” denotes a change in a facial expression, and the head pose “q^{o}” denotes a spatial location and a rotation angle of a face.

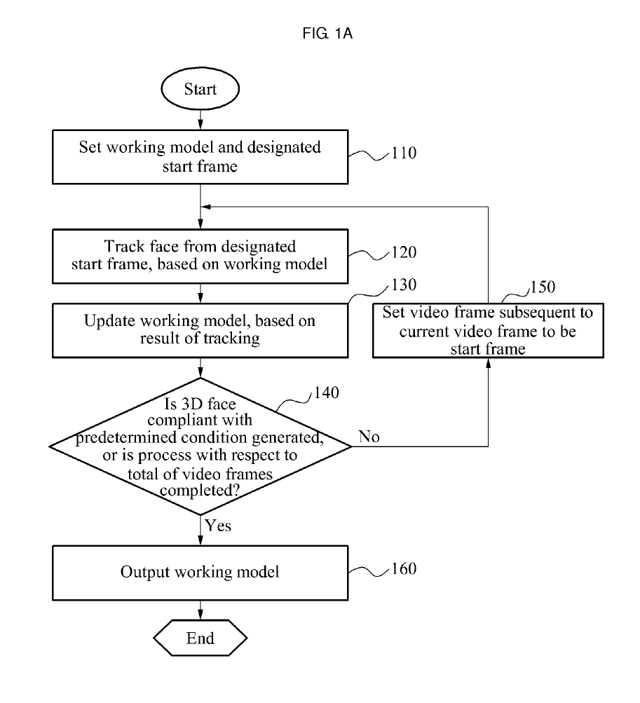

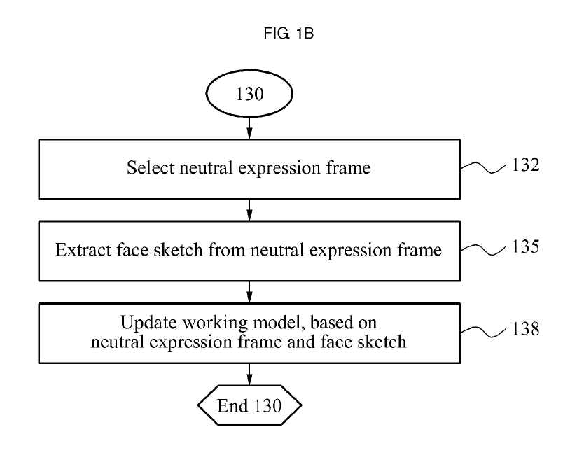

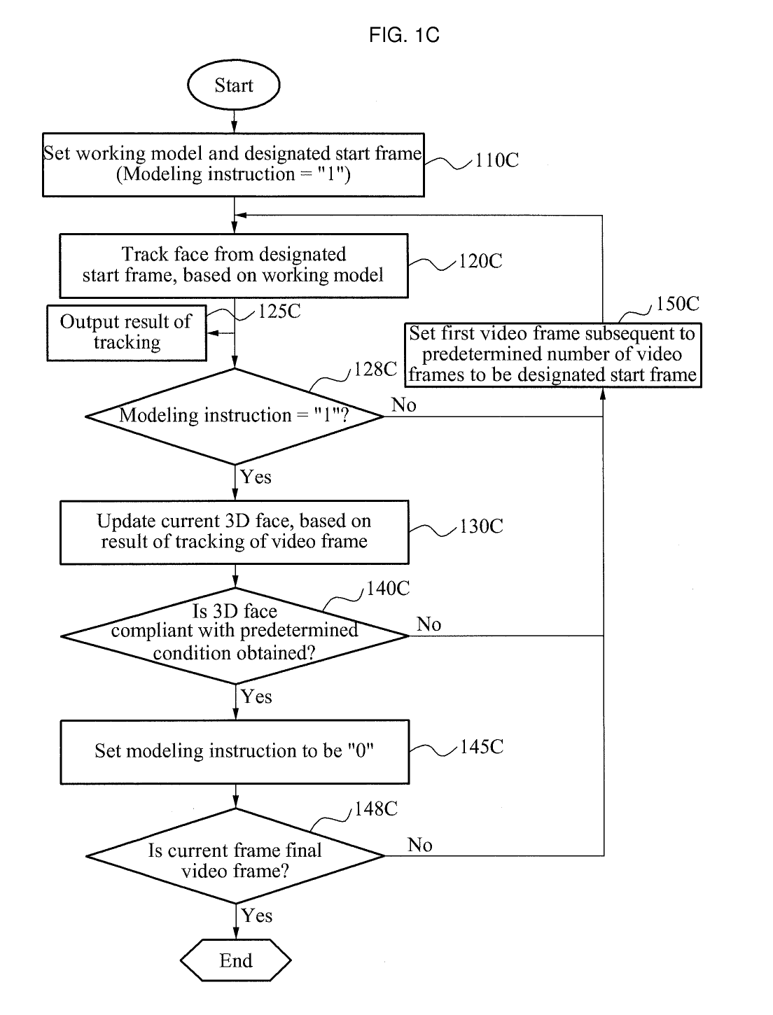

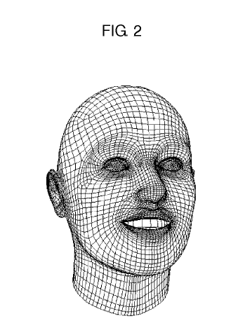

FIG. 1A illustrates a method for modeling a 3D face, according to example embodiments.

In operation 110, the method for modeling the 3D face may include setting a predetermined reference 3D face to be a working model, and setting a designated start frame to be a first frame. The reference 3D face may refer to a 3D face trained in advance, based on face data, and may include various expressions and poses. The designated start frame may refer to a video frame among the video frames being continuously inputted.

In operation 120, the method for modeling the 3D face may track a face from the designated start frame of a plurality of video frames inputted continuously based on a working model. While tracking the face, a face characteristic point, an expression parameter, and a head pose parameter may be extracted from the plurality of video frames tracked. The method for modeling the 3D face may generate a result of the tracking corresponding to a predetermined number of video frames by a predetermined condition. The result of the tracking generated may include the plurality of video frames tracked, the face characteristic point, the expression parameter, and the head parameter extracted from the plurality of video frames tracked. According to the example embodiments, the method for modeling the 3D face may include determining the predetermined number of video frames, based on an input rate, or determining a characteristic of noise of a plurality of video frames continuously inputted, or determining an accuracy requirement for the tracking. Further, the predetermined number of video frames may be a constant or a variable.

Moreover, in operation 120, the method for modeling the 3D face may output a result of the tracking generated via an input/output interface.

That is, in operation 120, the method for modeling the 3D face may include obtaining a face characteristic point, an expression parameter, and a head pose parameter from the plurality of video frames being tracked, using at least one of an active appearance model (AAM), an active shape model (ASM), and a composite constraint model (AAM). However, the above-described models are examples, and thus, the present disclosure is not limited thereto.

In operation 130, the method for modeling the 3D face may include updating a working model, based on the result of the tracking generated in operation 120. The updating of the working model will be described in detail with reference to FIG. 1B.

When the updating of the working model is completed in operation 130, the method for modeling the 3D face may output the working model updated via the input/output interface.

However, for example, when a difference between the appearance parameter of the updated working model and the appearance parameter of the working model prior to the updating is greater than or equal to a predetermined threshold value, and a video frame subsequent to a predetermined number of video frames is not a final video frame among a plurality of video frames continuously inputted, in operation 140, the method for modeling the 3D face may include setting a first video frame subsequent to the predetermined number of video frames to be a designated start frame in operation 150.

In other words, in operation 140, it is determined whether a difference between the appearance parameter of the updated working model and the appearance parameter of the working model prior to the updating is greater than or equal to a predetermined threshold value, and if so, the process proceeds to operation 150. Alternatively, it is determined whether a video frame subsequent to a predetermined number of video frames is not a final video frame among a plurality of video frames continuously inputted, and if so, the process proceeds to operation 150. Afterwards, the method for modeling the 3D face may perform the tracking of the face from the set start frame, based on the updated working model, by returning to operation 120.

However, for example, when the difference between the appearance parameter of the updated working model and the appearance parameter of the working model prior to the updating is less than the predetermined threshold value, and the video frame subsequent to the predetermined number of video frames is the final video frame among the plurality of video frames inputted continuously, the method for modeling the 3D face may perform operation 160. More particularly, the method for modeling the 3D face may halt the updating of the working model when an optimal 3D face compliant with the predetermined condition is generated, or a process with respect to a total of video frames is completed.

In operation 160, the method for modeling the 3D face may include outputting the updated working model to be an individualized 3D face.

FIG. 1B illustrates a process of 130 of FIG. 1A, according to example embodiments.

Referring to FIG. 1B, in operation 132, the method for modeling the 3D face may include selecting a video frame most similar to a neutral expression from the result of the tracking generated in operation 120 to be a neutral expression frame. The method for modeling the 3D face may include calculating expression parameters “eₖ^{t}(t=1:T, k=1:K)” with respect to a plurality of video frames tracked in order to select the neutral expression frame from the result of the tracking corresponding to a predetermined number “T” of video frames in operation 132. Here, “K” denotes a number of types of expression parameters. The method for modeling the 3D face may include setting an expression parameter value “ e̅ₖ̅ ” appearing most frequently among the expression parameters to be a neutral expression value, and selecting a video frame in which a deviation between a total of “K” number of expression parameters and the neutral expression value is less than a predetermined threshold value to be the neutral expression frame.

After the neutral expression frame has been set, the method proceeds to operation 135. In operation 135, the method for modeling the 3D face may include extracting a face sketch from the neutral expression frame, based on a face characteristic point included in the neutral expression frame. The method for modeling the 3D face may include extracting information including a face characteristic point, an expression parameter, a head pose parameter, and the like, with respect to the plurality of video frames tracked in operation 120, and extracting a face sketch from the neutral expression frame selected in operation 132, using an active contour model algorithm.

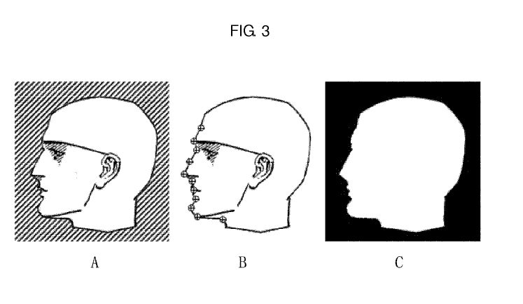

An example of extracting of the information including a face characteristic point, an expression parameter, and a head pose, for example, from a neutral expression frame may be illustrated in FIG. 3. Images A, B, and C of FIG. 3 illustrate examples in which a face sketch is extracted from a video frame, using a face characteristic point. According to the example embodiments, when a sketch is extracted from a video frame of the image A, a face characteristic point, for example, the image B, of the video frame may be referenced, and a face sketch, for example, the face sketch shown in the image C, may be extracted from the video frame, using the active contour model algorithm. Through such a process, the face sketch may be extracted from the neutral expression frame.

In operation 138, the method for modeling the 3D face may include updating a working model, based on the face characteristic point of the neutral expression frame and the face sketch extracted. More particularly, the method for modeling the 3D face may include updating the head pose “q” of the working model to a head pose of the neutral expression frame, and setting the expression component “e” of the working model to be “0”. Also, the method for modeling the 3D face may include correcting the appearance component “a” of the working model by matching the working model “S(a, e, q)” to a location of the face characteristic point of the neutral expression frame, and matching a face sketch calculated through the working model “S(a, e, q)” to the face sketch extracted from the neutral expression frame.

The method for modeling the 3D face may include re-setting the expression component “e” of the working model to be “0”, and re-performing the generating when the face tracking fails.

For example, the image B of FIG. 4 illustrates a result generated through matching a working model to the face characteristic point of the neutral expression frame represented in the image A of FIG. 4. The image D of FIG. 4 illustrates adjusting a working model to match the working model to a face sketch extracted, or correcting an appearance parameter.

In the correcting of the appearance component, for example, the method for modeling the 3D face may include recording and comparing a numerical value of an appearance parameter prior to the correcting to a numerical value of the appearance parameter subsequent to the correcting in operation 140.

The tracking of the face and the updating with respect to the video frame continuously inputted may be performed in operations 120 through 150 shown in FIG. 1A. According to the example embodiments, operations 120 to 130 may be performed simultaneously or sequentially. As such, a face model most similar to a face of a user may be obtained, using a current working model, by performing tracking of the face of the user and updating the current working model based on a result of the tracking.

That is, using a corresponding video frame, a face characteristic point, an expression parameter, and a head pose parameter may be extracted; and the working model may be updated based on the extracted face characteristic point and the head pose parameter. Also, a result of the tracking of the face with respect to a plurality of video frames inputted may be outputted, and the result of the tracking of the face may include an expression parameter, an appearance parameter, and a head pose parameter.

FIG. 10 illustrates a method for tracking a face, according to example embodiments.

The method for tracking the face is primarily directed to output a result of tracking a face. In FIG. 10, the method for tracking the face may not including performing an update of a working model, however, tracking of a face with respect to a video frame may be performed subsequent to a current video frame when an optimal model compliant with a predetermined condition is obtained.

Referring to FIG. 10, when the method for modeling the 3D face is conducted, the method for tracking the face may include setting a predetermined reference 3D face to be a working model, setting a designated start frame to be a first frame, and setting a variable determining whether updating a working model continues to be performed. For example, in setting the variable, the variable may be represented by a bit or by a “Yes”/“No” determination, e.g., to be “1” or “Yes” in operation 110C. This variable may be referred to as a modeling instruction. The reference 3D face may refer to a 3D face of which a series of expressions and poses are trained in advance.

Operation 120C illustrated in FIG. 10 may be identical to 120 of FIG. 1A. However, in FIG. 10, operations 125C and 128C may be performed subsequent to tracking of a face with respect to a predetermined number of video frames being completed. In operation 125C, the method for tracking the face may include outputting a result of the tracking with respect to a plurality of video frames tracked. For example, the result of the tracking may include expression parameters, appearance parameters, and head pose parameters.

In operation 128C, the method for tracking the face may include determining whether the updating of the working model continues to be performed, for example, determining whether a modeling instruction is set to be “1”. When the modeling instruction is determined to be “1”, the method for tracking the face may perform operation 130C. Operation 130C of FIG. 10 may be identical to operation 130 of FIG. 1A.

In the updating of the working model in operation 140C, when a difference between an appearance parameter of the working model updated and an appearance parameter of the working model prior to the updating is greater than or equal to a predetermined threshold value, the method for tracking the face may set a first video frame subsequent to the predetermined number of video frames to be the designated start frame. Subsequently, the method for tracking the face may return to operation 120C to perform the tracking of the face from the designated start frame, based on the updated working model.

According to other example embodiments, in the updating of the working model, when a difference between the appearance parameter of the working model updated and the appearance parameter of the working model prior to the updating is less than or equal to the predetermined threshold value, the method for tracking the face may include setting the modeling instruction determining whether the updating of the working model continues to be performed to be “0” or “No”, in operation 145C. In particular, when a 3D face most similar to a face of a user is determined to be generated, the method for tracking the face may no longer perform the updating of the working model.

In operation 148C, the method for tracking the face may include verifying whether a video frame subsequent to the predetermined number of video frames is a final video frame among a plurality of video frames inputted continuously. When the video frame subsequent to the predetermined number of video frames is verified not to be the final video frame among the plurality of video frames inputted continuously, the method for tracking the face may perform operation 150C. Operation 150C may include setting a first video frame subsequent to the predetermined number of video frames to be the designated start frame, and then the process may return to operation 120.

The method for tracking the face may be completed when the video frame subsequent to the predetermined number of video frames is the final video frame among the plurality of video frames continuously inputted.

According to the example embodiments, the method for tracking the face may output a working model updated for a last time, prior to the method for tracking the face being completed.

As such, the method for tracking the face may perform continuous tracking with respect to a face model most similar to a face of a user, and output a more accurate result of the tracking, through the tracking of the face being performed; extracting a face characteristic point, an expression parameter, and a head pose parameter; and updating the working model based on the extracted face characteristic point, the head pose parameter, and a corresponding video frame, using a current working model.

A 3D face model more similar to a face of a user may be provided through tracking a face continuously in a video frame, including a face inputted continuously, and updating the 3D face based on a result of the tracking. In addition, high accuracy facial expression information may be outputted through tracking the face continuously in the video frame including a face, inputted continuously, and updating the 3D face based on a result of the tracking.

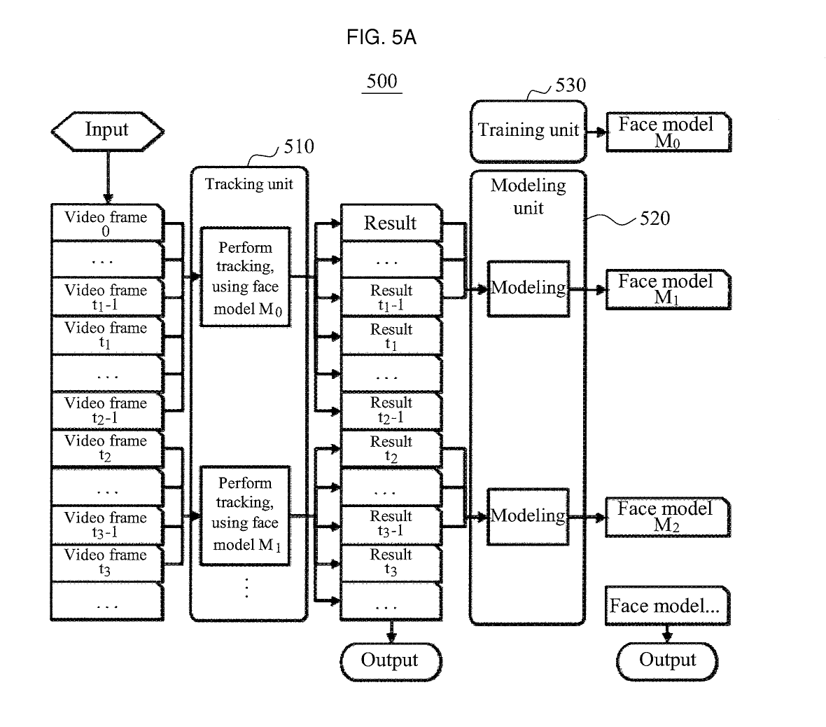

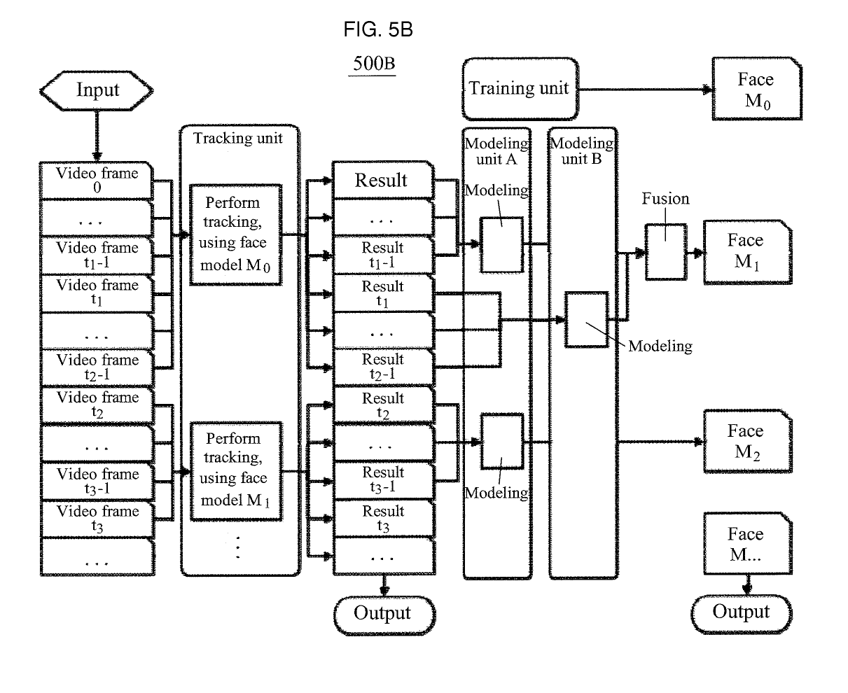

FIG. 5A illustrates an apparatus 500 for implementing a method for modeling a 3D face and method for tracking a face, according to example embodiments.

The apparatus 500 for implementing the method for modeling the 3D face and method for tracking the face may include a tracking unit 510 and a modeling unit 520. The tracking unit 510 may perform operations 110 to 120 illustrated in FIG. 1A, or operations 110C through 125C illustrated in FIG. 10, and the modeling unit 520 may perform operations 130 through 150 illustrated in FIG. 1A or operations 130C through 150C in FIG. 10. Each of the above-described units may include at least one processing device.

Referring to FIG. 5A, the tracking unit 510 may track a face with respect to input video frames “0” to “t₂−1”, inputted continuously, using a working model, for example, a reference 3D face model “M₀”. Further, and the tracking unit 510 may output a result of the tracking, for example, results “0” to “t₂−1” illustrated in FIG. 5A, including the video frames “0” to “t₂−1”, a face characteristic point extracted from a plurality of video frames, an expression parameter, and a head pose parameter. The result of the tracking may be provided to the modeling unit 520, and outputted to a user via an input/output interface, as necessary.

The modeling unit 520 may update the working model, based on the result of the tracking, for example, the results “0” to “t₂−1”, outputted from the tracking unit 510. For any descriptions of the updating, reference may be made to analogous features described in FIGS. 1A and 1B. For example, hereinafter, “M₁” of FIG. 5A refers to the updated working model.

Subsequently, the tracking unit 510 may track a face with respect to video frames “t₂” to “t₃”, based on the updated working model “M₁”, compliant with a predetermined rule (refer to the descriptions provided with reference to FIG. 1A), and output a result of the tracking, results “t₂” to t₃”. The modeling unit 520 may update the working model “M₁”, based on results “t₂” to “t₃−1”. However, the present disclosure is not limited to the illustration of FIG. 5A. That is, a different number of video frames may be used for tracking and modeling. The tracking of the face and the updating of the working model may be performed repeatedly until an optimal model is obtained compliant with a condition, or all of the video frames have been inputted. The tracking unit 510 and the modeling unit 520 may operate simultaneously.

The apparatus for implementing the method for modeling the 3D face and method for tracking the face may further include a training unit 530 to train a reference 3D face in advance to set the reference 3D face to be a working model “M₀”, through a series of off-line 3D face data, however, the present disclosure is not limited thereto.

FIG. 5B illustrates an apparatus 500B for implementing a method for modeling a 3D face and method for tracking a face, according to another example embodiment.

The apparatus 500B for implementing the method for modeling the 3D face and/or method for tracking the face of FIG. 5B, unlike the apparatus of FIG. 5A, may include a plurality of modeling units, for example, a modeling unit A and a modeling unit B, perform operation 130 repeatedly, through alternative use of the plurality of modeling units, and integrate a result of the repeated performing.

A portable device as used throughout the present disclosure may include mobile communication devices, such as a personal digital cellular (PDC) phone, a personal communication service (PCS) phone, a personal handy-phone system (PHS) phone, a Code Division Multiple Access (CDMA)-2000 (1X, 3X) phone, a Wideband CDMA phone, a dual band/dual mode phone, a Global System for Mobile Communications (GSM) phone, a mobile broadband system (MBS) phone, a satellite/terrestrial Digital Multimedia Broadcasting (DMB) phone, a Smart phone, a cellular phone, a personal digital assistant (PDA), an MP3 player, a portable media player (PMP), an automotive navigation system (for example, a global positioning system), and the like. Also, the portable device as used throughout the present disclosure may include a digital camera, a plasma display panel, and the like.

The method for modeling the 3D face and method for tracking a face according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Further, according to an aspect of the embodiments, any combinations of the described features, functions and/or operations can be provided.

Moreover, the apparatus as shown in FIGS. 5A-5B, for example, may include at least one processor to execute at least one of the above-described units and methods.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. A method for modeling a three-dimensional (3D) face, the method comprising:
setting a predetermined reference 3D face to be a working model, and tracking a face, based on the working model;
generating a result of the tracking including at least one of a face characteristic point, an expression parameter, and a head pose parameter from a video frame;
updating the working model, based on the result of the tracking.

2. The method of claim 1, wherein the tracking the face comprises tracking the face in a unit of the video frame, and wherein the face is included in the video frame.

3. The method of claim 1, wherein the 3D face comprises:
at least one of a 3D shape of a face, appearance parameters, expression parameters, and head pose parameters.

4. The method of claim 1, wherein the generating of the result of the tracking comprises:
generating results of the tracking corresponding to a predetermined number of video frames, based on a start frame designated among video frames inputted.

5. The method of claim 1, wherein the updating of the working model comprises:
determining whether to update the working model based on comparison of a difference between an appearance parameter of the updated working model and an appearance parameter of the working model prior to the updating with a predetermined threshold value.

6. The method of claim 1, wherein the working model of the 3D face is represented in an equation:
S(a, e, q)=T(ΣaᵢSᵢ^{a}+ΣeⱼSⱼ^{e}; q),
wherein “S” denotes a 3D shape, “a” denotes an appearance component, “e” denotes an expression component, “q” denotes a head pose, “T(S, q)” denotes a function performing at least one of an operation of rotating the 3D shape “S” based on the head pose “q” and an operation of moving the 3D shape “S” based on the head pose “q”.

7. The method of claim 6, wherein the predetermined reference 3D face comprises:
an average shape “s^{o}”, an appearance component “Sᵢ^{a}”, an expression component “Sᵢ^{e}”, and a reference head pose “q^{o}”, and
“i=1:N, Sᵢ^{a}” denotes a change in a face appearance, and “j=1:M, Sⱼ^{e}” denotes a change in a facial expression.

8. The method of claim 1, further comprising:
training a reference 3D face, in advance, through off-line 3D face data, and setting the trained reference 3D face as a working model.

9. The method of claim 1, wherein the generating of the result of the tracking and the updating of the working model are performed simultaneously.

10. The method of claim 1, wherein the updating of the working model comprises:
selecting a video frame, from the generated result of the tracking, most similar to a neutral expression to be a neutral expression frame;
extracting a face sketch from the selected neutral face frame, based on a face characteristic point included in the neutral expression frame; and
updating the working model, based on the face characteristic point included in the neutral expression frame and the extracted face sketch.

11. The method of claim 10, wherein the selecting of the video frame comprises:
calculating expression parameters with respect to a plurality of video frames tracked;
setting an expression parameter appearing most frequently among the expression parameters to be a neutral expression value; and
selecting a video frame in which a deviation between a total of “K” number of expression parameters and the neutral expression value is less than a predetermined threshold value.

12. The method of claim 10, wherein the extracting of the face sketch comprises:
extracting a face sketch from the neutral expression frame, using an active contour model algorithm.

13. The method of claim 6, wherein the updating of the working model comprises:
updating the head pose “q” of the working model to be a head pose of the neutral expression frame;
setting an expression component “e” of the working model to be “0”; and
correcting the appearance component “a” of the working model by matching the working model “S(a, e, q)” to a location of the face characteristic point of the neutral expression frame, and matching a face sketch calculated through the “S(a, e, q)” to the face sketch extracted from the neutral expression frame.

14. The method of claim 1, wherein in the updating of the working model, the working model is continuously updated, and a result of the continuous updating in the working model is reflected.

15. The method of claim 1, wherein the generating of the result of the tracking comprises:
determining a number of video frames on which tracking is to be performed based on at least one of an input rate of a video frame inputted, a characteristic of noise, and an accuracy requirement for the tracking.

16. The method of claim 1, wherein the generating of the result of the tracking comprises:
obtaining at least one of a face characteristic point, an expression parameter, and a head pose parameter, using at least one of an active appearance model (AAM), an active shape model (ASM), and a composite constraint model (AAM).

17. An apparatus for modeling a three-dimensional (3D) face, the apparatus comprising:
a tracking unit to track a face based on a working model, and generate a result of tracking including at least one of a face characteristic point, an expression parameter, and a head pose parameter; and
a modeling unit to update the working model, based on the result of the tracking.

18. The apparatus of claim 17, wherein the tracking unit tracks the face based on the working model with respect to a video frame inputted.

19. The apparatus of claim 17, further comprising:
a training unit to train a 3D reference face, in advance, through off-line 3D face data, and setting the trained reference to be the working model.

20. The apparatus of claim 17, wherein the modeling unit comprises a plurality of modeling units to repeatedly perform updating of the working model through alternative use of the plurality of modeling units.
